(19) United States
(12) Patent Application Publication
(10) Pub. No.: US 2010/0150581 A1
(43) Pub. Date: Jun. 17, 2010

(54) IMAGE FORMING APPARATUS

(76) Inventors: Hideki NAKAMURA, Tokyo (JP); Kazumichi Yamauchi, Tokyo (JP); Akira Okamoto, Tokyo (JP); Yoshiki Katayama, Tokyo (JP); Kazutoshi Yoshimura, Tokyo (JP); Masatoshi Ogawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/638,453

(22) Filed: Dec. 15, 2009

(30) Foreign Application Priority Data
Dec. 16, 2008 (JP) 2008-319266

(51) Int. Cl. G03G 15/00

(52) U.S. Cl. 399/18

(57) ABSTRACT

Disclosed is an image forming apparatus including a unit in which a replaceable part is loaded, an image forming section to form an image on a recording medium by an operation of the unit, a malfunction detection section to detect a malfunction of the unit or the part and a control section to carry out a control of the image forming apparatus, and when an operation mode to executed an image forming by the image forming section is an image forming mode and when the operation mode which allows a maintenance/replacement of the unit is a maintenance/replacement mode, the control section changes a control of the image forming apparatus according to whether the operation mode when the malfunction was detected by the malfunction detection section is the image forming mode or the maintenance/replacement mode.

### BACKGROUND OF THE INVENTION

1. Field of the Invention

The present invention relates to an image forming apparatus.

2. Description of Related Art

Conventionally, maintenance/replacement (maintenance) of an image forming apparatus such as a copier is carried out by a serviceman who has technical knowledge. When the serviceman is called to carryout the maintenance/replacement, there is a problem that the time until the serviceman arrives becomes a downtime of the machine and a problem that service cost is needed. Therefore, in recent years, a desire for a user (operator) of the machine her/himself wanting to carryout the maintenance/replacement (replacement of parts and the like) is becoming greater. Further, support techniques such as an operation guidance display and the like are suggested so that a safe and appropriate maintenance/replacement operation can be carried out.

For example, JP2005-172902 discloses a technique of graphically displaying appropriate and easy-to-understand various types of maintenance methods corresponding to various skill levels of operators.

Further, in JP2005-172902, guidance for different levels regarding each of the maintenances is stored step-by-step in a storage section in an image forming apparatus so that a skill level of an operator is determined and a guidance appropriate for the skill level can be displayed. This apparatus allows the maintenance be easy and efficient by downloading detail guidance information to the image forming apparatus from an external information processing apparatus when the content of the stored guidance is not sufficient.

On the other hand, there is an image forming apparatus which detects break down of parts, defects of functions and the like and which includes a malfunction detection function that urges for checking to be carried out by a serviceman. However, in a case of such image forming apparatus having the malfunction detection function, there is a problem that a downtime occurs after all because a serviceman call may be displayed when an operator cannot complete the maintenance/replacement operation properly.

### SUMMARY OF THE INVENTION

In view of the above problems, an object of the present invention is to provide an image forming apparatus which can extend targets to which the maintenance/replacement operation can be carried out and which can reduce downtime associated with the maintenance replacement operation.

According to a first aspect of the present invention, there is provided an image forming apparatus comprising a unit in which a replaceable part is loaded, an image forming section to form an image on a recording medium by an operation of the unit, a malfunction detection section to detect a malfunction of the unit or the part and a control section to carry out a control of the image forming apparatus, and when an operation mode to executed an image forming by the image forming section is an image forming mode and when the operation mode which allows a maintenance/replacement of the unit is a maintenance/replacement mode, the control section changes a control of the image forming apparatus according to whether the operation mode when the malfunction was detected by the malfunction detection section is the image forming mode or the maintenance/replacement mode.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a block diagram showing an example of functional structure of an image forming apparatus 100 of the embodiment;

FIG. 2 is a diagram showing an example of data storage of a unit management information region 111;

FIG. 3 is a diagram showing an example of data storage of a part management information region 112;

FIG. 4 is a diagram showing an example of an operation section 20;

FIG. 5 is a diagram showing an example of data storage of an IC tag 70;

FIG. 6 is a flowchart showing an example (malfunction detection process 1) of a malfunction detection process which is carried out in the image forming apparatus 100 of the embodiment;

FIG. 7 is a diagram showing an example of a display section 22 in which a warning message is displayed;

FIG. 8 is a diagram showing an example of the display section 22 in which a serviceman call is displayed;

FIG. 9 is a flowchart showing an example (malfunction detection process 2) of the malfunction detection process which is carried out in the image forming apparatus 100 of the embodiment; and

FIG. 10 is a flowchart showing an example (malfunction detection process 3) of the malfunction detection process which is carried out in the image forming apparatus 100 of the embodiment.

### DESCRIPTION OF THE PREFERRED EMBODIMENTS

Hereinafter, an embodiment of the present invention will be described based on the drawings.

First, a structure will be described.

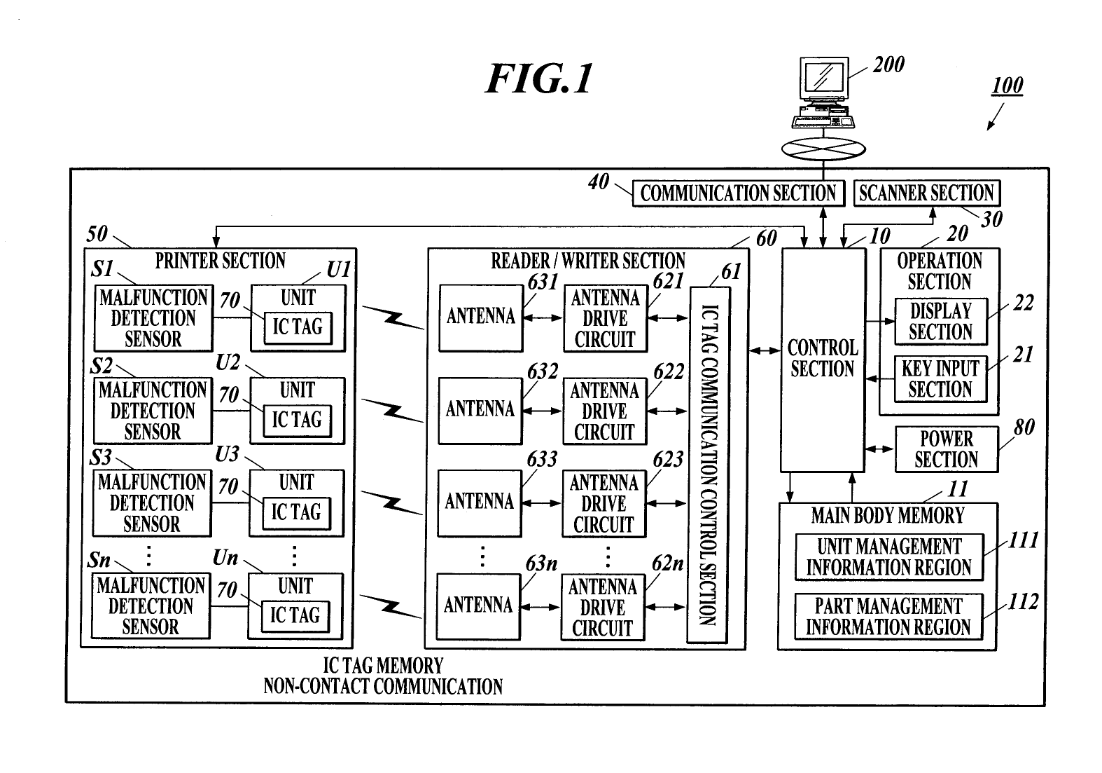

An example of functional structure of the image forming apparatus 100 of the embodiment is shown in FIG. 1.

As shown in FIG. 1, the image forming apparatus 100 comprises a control section 10, an operation section 20, a scanner section 30, a communication section 40, a printer section 50, a reader/writer section 60, a power section 80 and the like.

The control section 10 comprises CPU (Central Processing Unit), ROM (Read Only Memory), RAM (Random Access Memory) and the like. In the ROM, various types of processing programs are stored. The CPU reads the various types of programs stored in the ROM and expands the programs in the RAM, and further, controls operation of each part of the image forming apparatus 100 according to the expanded programs.

The control section 10 receives a malfunction detection signal which is transmitted when malfunction detection sensors S1 to Sn which are respectively provided for each of the units detect a malfunction, and further, the control section 10 carries out a control according to an operation mode which is selected at the time when the malfunction detection signal was received. In the embodiment, there are an image forming mode to execute a regular image forming and a maintenance/replacement mode to allow maintenance/replacement be carried out to the units are the operation modes. That is, the control section 10 changes the control of the image forming apparatus 100 according to whether the operation mode at the time when a malfunction was detected by the malfunction detection sensors Si to Sn is the image forming mode or the maintenance/ replacement mode. Further, the control section 10 functions as a power control section which can control input and output of power which is provided to the units.

Moreover, a main body memory 11 is connected to the control section 10. The main body memory 11 comprises a nonvolatile memory and the like, and includes a unit management information region 111 and a part management information region 112 as shown in FIG. 1. Further, the main body memory 11 functions as a storage section to store the occurrence record of malfunction and the detected state of malfunction that are detected by the malfunction detection sensors S1 to Sn.

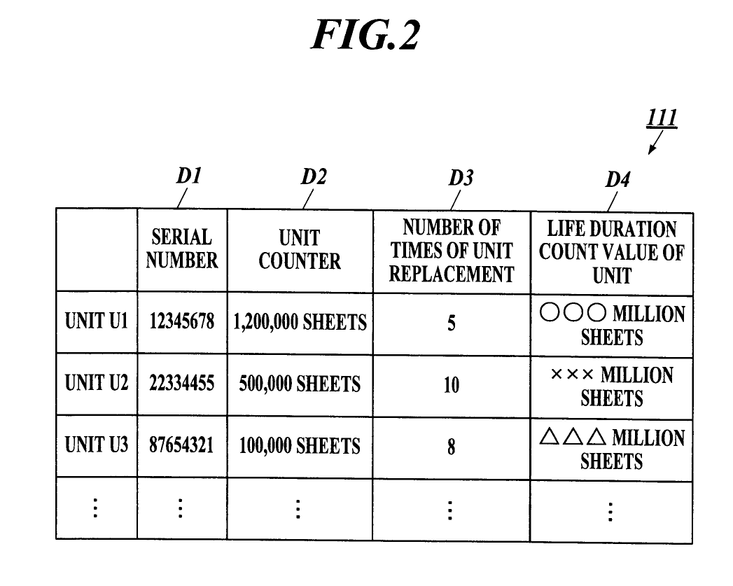

An example of data storage of the unit management information region 111 is shown in FIG. 2.

As shown in FIG. 1, the printer section 50 of the image forming apparatus 100 is provided with replaceable units U1 to Un in each of which a plurality of replaceable units are loaded. The number of units to be provided at the printer section 500 may be one or may be plurality, and the number is not limited. Further, the malfunction detection sensors S1 to Sn are provided so as to respectively correspond to the units U1 to Un. The malfunction detection sensors S1 to Sn function as a malfunction detection sections to detect malfunction of the units or the parts.

As shown in FIG. 2, the unit management information region 111 stores the unit management information constituted of a serial number D1, a unit counter D2, number of times of unit replacement D3 and life duration count value of unit D4 of the unit for each of the units U1 to Un which are loaded in the printer section 50.

The serial number D1 is individual identification information to identify individual units. The unit counter D2 is a value in which number of times the unit has been used is indicated as number of prints (print count value). This is a value where one side is counted as 1 print in case of a double-sided print. The number of times of unit replacement D3 is a value indicating the number of times the unit has been replaced (number of times of detachment). The life duration count value of unit D4 is a value in which the life duration of the unit is indicated in a print count value.

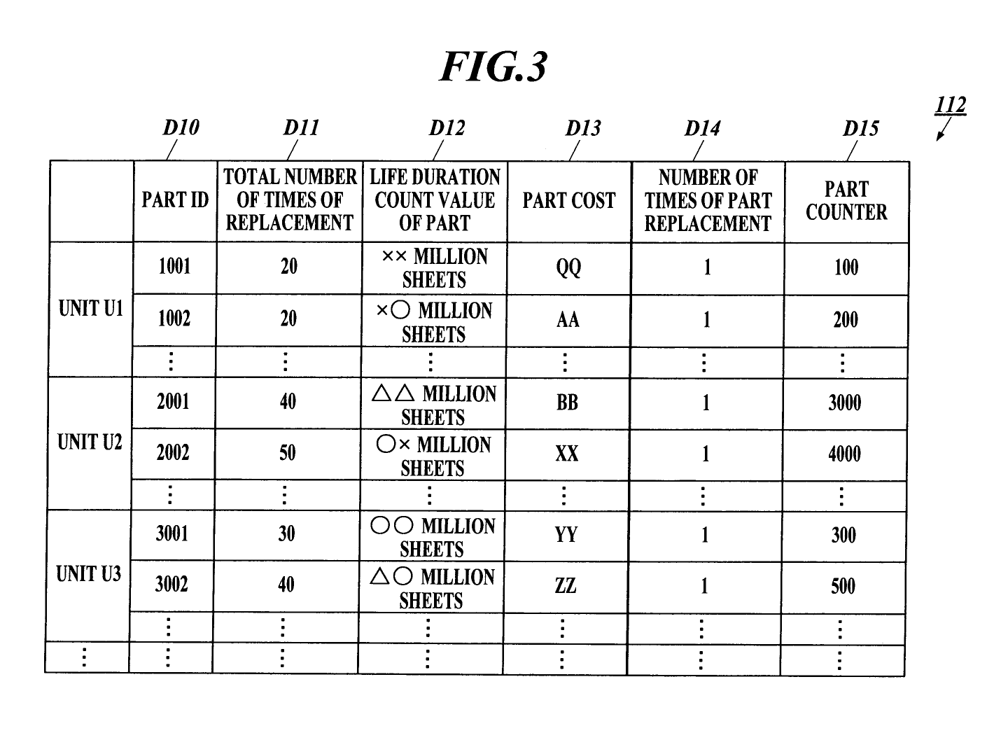

An example of data storage of the part management information region 112 is shown in FIG. 3.

As shown in FIG. 3, the part management information region 112 stores the part management information such as a part ID D10, a total number of replacement D11, a life duration count value of part D12, a part cost D13, a number of times of part replacement D14, a part counter D15 and the like of each of the parts which are mounted at the units for each of the units U1 to Un.

The total number of replacement D11 is the number of times the part has been replaced since the image forming apparatus 100 was set up until present time. The life duration count value of part D12 is a print count value indicating the life duration of the part. The number of times of part replacement D14 is the number of times the part has been replaced in the unit which is now being used. The part counter D15 is a value in which the number of times the part which is now being used has been used is indicated in a print number (print count value).

Here, the life duration count value of part D12 and the part cost D13 of each of the parts may be managed by a host apparatus 200 or the like which is connected via the communication network.

Moreover, in the main body memory 11, the standard value of life duration of each of the parts which are loaded in the units U1 to Un are stored in advance (not shown in the drawing). The standard value of life duration is a print count value indicating the life duration of each of the parts which is set in advance by a manufacturer.

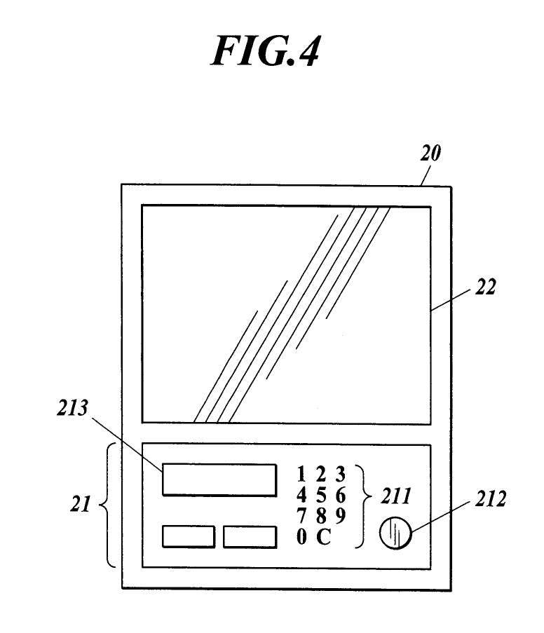

Referring to FIG. 1 again, the operation section 20 comprises a key input section 21, a display section 22 and the like. The operation section 20 accepts a selection input of an item which is to be a target for maintenance/replacement and an input of maintenance/replacement completion. When the control section 10 accepts the selection input of the item by the operation section 20, the control section 10 switches the operation mode to the maintenance/replacement mode from the image forming mode. Further, when the control section 10 accepts the input of the maintenance/replacement completion by the operation section 20, the control section 10 switches the operation mode to the image forming mode from the maintenance/replacement mode. An example of the operation section 20 is shown in FIG. 4.

As shown in FIG. 4, the key input section 21 comprises various types of operation keys such as a numerical keypad 211, a start key 212, a mode key 213, a power key to switch the power on/off and the like. For example, the selection operation of the item targeted for maintenance/replacement and the completion operation of maintenance/replacement operation for switching the operation mode to the maintenance/replacement mode from the image forming mode are carried out by operation of various types of operation keys. When the operation key is pushed by an operator, an operation signal corresponding to the operation key is generated and outputted to the control section 10.

The display section 22 comprises LCD (Liquid Crystal Display) and the like, and carries out a display of various types of operation screens, a display of image condition, a display of operation state of each function and the like according to an instruction of display signal which is inputted from the control section 10. Further, the display section 22 displays the item which is to be the target for maintenance/replacement.

The scanner section 30 comprises a platen glass, CCD (Charge Coupled Device) and a light source. The scanner section 30 reads the document image which is set at a predetermined position as a R, G, B signal by carrying out a photoelectric conversion by imaging the reflection of the light which was illuminated to the document for the light source and which scanned the document, and converts the read analog image signal to the image data of R, G and B and outputs the image data to the control section 10.

The communication section 40 is an interface which can be connected to a transmission medium connected to a communication network such as LAN (Local Area Network), WAN (Wide Area Network) and the like. For example, the communication section 40 is constituted of a communication control card such as LAN card and the like, and carries out sending and receiving of various types of data between an external device such as the host apparatus 200 for image data transmission which is connected to the communication network via a communication circuit such as a LAN cable. The host apparatus 200 is a computer comprising a control section comprising CPU and the like, an operation section, a display section, a storage section and a communication section.

The printer section 50 includes replaceable units U1 to Un such as a unit U1 which is a paper feeding unit, a unit U2 which is a development unit, a unit U3 which is a drum unit, a unit U4 which is an intermediate transfer unit, a unit U5 which is a fixing unit, a unit U6 which is an exposure unit and the like, and the printer section 50 carries out an image forming (print) on a paper by an electrophotographic process. That is, the printer section 50 functions as an image forming section to form an image on a recording medium such as paper by the operation of the units U1 to Un. In particular, an electrostatic latent image is formed by exposing and scanning the photoreceptor drum of the unit U3 by a laser beam which is emitted from the unit U6 based on the image data inputted from the control section 10. Thereafter, a toner image is formed by adsorbing the developer on the photoreceptor drum in the unit U2. The toner image formed on the photoreceptor drum is transferred to the primary transfer roller of the nit U4, and then, is transferred on a paper which is to be conveyed by the paper feeding roller of the unit U1. The toner image transferred on the paper is heated and fixed by a fixing roller of the fixing unit U5.

The units U1 to Un of the printer section 50 have parts which wear out by carrying out printing to the papers. For example, as parts which are included in the unit U1, there are a paper feeding roller to convey paper, a paper feeding clutch to transmit power from the drive source (not shown in the drawing) to the paper feeding roller and the like. These parts which wear out are replaceable, and when the value of the part counter D15 reaches the value of the life duration count value of part D12, the unit in which new part is loaded by the unit being drawn out by an operator. Alternatively, after the part is replaced, the unit is loaded again.

Here, the printer section 50 has been described by exemplifying a structure for carrying out the image forming on a paper by the electrophotographic process. However, the image forming may be carried out to a paper by an ink-jet method, a thermal-transfer method and the like. For example, in a case of the ink-jet method, ink tanks, ink nozzles and the like will be the units or parts which are target for maintenance.

In the embodiment, an IC tag 70 is attached to each of the units which are loaded in the printer section 50 as a recording medium.

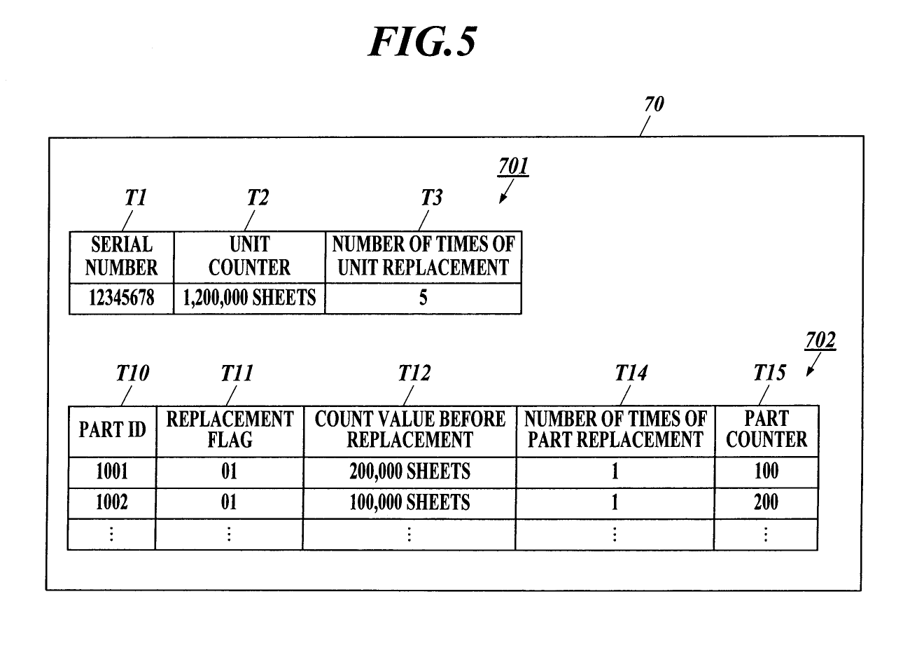

An example of data storage in the IC tag 70 is shown in FIG. 5. As shown in FIG. 5, the IC tag 70 includes the unit management information region 701 and the part management information region 702.

The unit management information region 701 stores the unit management information such as a serial number T1, a unit counter T2, number of times of unit replacement T3 and the like of the unit. The serial number T1, the unit counter T2 and the number of times of unit replacement T3 are data in same format as the serial number D1, the unit counter D2 and the number of times of unit replacement D3 which are stored in the main body memory 11, respectively.

The part management information region 702 stores the part management information such as apart ID T10, a replacement flag T11, a count value before replacement T12, a number of times of part replacement T14, a part counter T15 and the like for each of the parts which are loaded in the unit.

The replacement flag T11 is information indicating whether replacement is needed or not. “10” indicates that the replacement is needed and “01” indicates that the replacement is already carried out. Here, when the unit including a part which is already replaced, indicated as “01”, is loaded in the image forming apparatus 100 and when the unit is started to be used in the image forming apparatus 100, the replacement flag T11 will be changed to the initial state of “00” from “01”.

The count value before replacement T12 is a value of the part counter T15 of the old part before the replacement. The part management information of the IC tag 70 is updated by a PC (personal computer) and a reader/writer in which a special application is loaded at the time when the replacement is carried out by a serviceman.

The part ID T10, the number of times of part replacement T14 and the part counter T15 are data in same format as the part ID D10, the number of times of part replacement D14 and the part counter D15 stored in the main body memory 11, respectively.

Referring to FIG. 1 again, the reader/writer section 60 comprises an IC tag communication control section 61, antenna drive circuits 621 to 62n and antennas 631 to 63n. The antenna drive circuits 621 to 62n and the antennas 631 to 63n respectively correspond to each of the units U1 to Un, and the antennas 631 to 63n are respectively provided at positions which are opposite of each of the units U1 to Un. The IC tag communication control section 61 controls the antenna drive circuits 621 to 62n based on an instruction from the control section 10, carries out an electromagnetic induction to the IC tags 70 of the units U1 to Un via the antennas 631 to 63n and carries out sending and receiving of data by non-contact communication. Further, the IC tag communication control section 61 carries out reading and writing of data to the IC tag 70 of each of the units U1 to Un.

The power section 80 is connected to the commercial AC source (not shown in the drawing), and converts the AC (alternate current) which is inputted from the commercial AC source to DC (direct current) power and supplies electricity to each section if necessary. The power section 80 supplies power according to the control command from the control section 10 which functions as the power control section.

Next, an operations in the embodiment will be described.

In the image forming apparatus 100, every time when printing is carried out for one side at the printer section 50, the part counter D15 of each of the parts in the main body memory 11 is incremented by 1 by the control section 10. When a series of printing (job) in the printer section 50 is finished, the life duration count value of part D12 is compared to the part counter D15 for each part stored in the part management information region 112 by the control section 10 and whether a part which have reached its life duration exists or not is determined. The part in which the part counter D15≧the life duration count value of part D12, that is, when a part which have reached its life duration exists, the part replacement informing screen (not shown in the drawing) is to be displayed in the display section 22. In the part replacement informing screen, the part name of the part which needs to be replaced, that is the part name of the part which reached its life duration and a message for urging replacement of the unit in which the part which needs to be replaced is loaded are to be displayed.

At the time when the part reaches its life duration, at the time when power off is instructed by an operation of the power key or at the time of transition to the power save mode, information of the IC tag 70 of each of the units U1 to Un is updated based on information stored in the main body memory 11. The updating is carried out at the time when the part reaches its life duration, at the time of power off or at the time of the power save mode because there is a possibility that the units U1 to Un are removed to carry out replacement of parts and the units U1 to Un.

### First Embodiment

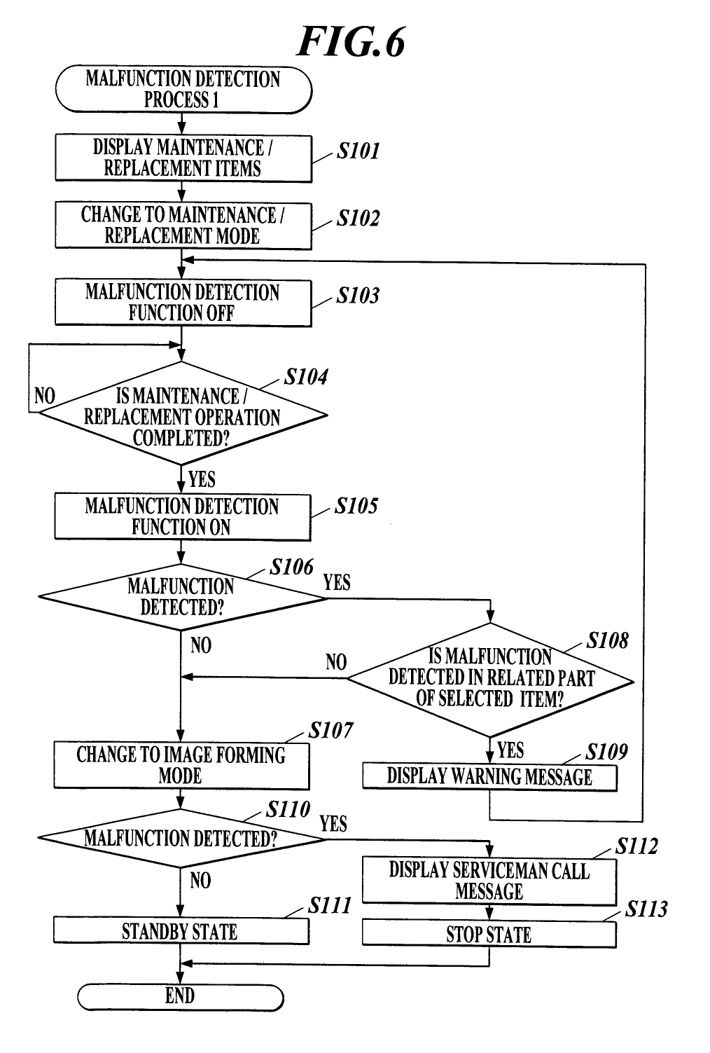

FIG. 6 is a flowchart showing an example (malfunction detection process 1) of the malfunction detection process which is carried out in the image forming apparatus 100 according to the embodiment. In the embodiment, when the maintenance cycle (life duration) which is set for each unit is reached, maintenance/replacement by an operator is to be carried out. Here, the malfunction detection process is to be carried out at an occasion when the maintenance/replacement is selected to be carried out by a key operation of an operator.

When the maintenance/replacement is selected to be carried out by an operator, items which are targeted for maintenance/replacement are displayed in step S101 as shown in FIG. 6. When the items which are targeted for the maintenance/replacement are displayed, an item to which the maintenance/replacement is to be carried out is selected among the displayed items.

When the item to which the maintenance/replacement is to be carried out is selected, the operation mode is switched to the maintenance/replacement mode in step S102.

When the operation mode is switched to the maintenance/replacement mode, the function of the malfunction detection sensors S1 to Sn to detect malfunction (malfunction detection function) is turned OFF in step S103. Here, the malfunction detection function is turned OFF so as not to detect the detachment of a unit in association to the maintenance/replacement operation or the like as “malfunction”.

In step S104, whether the maintenance/replacement operation is completed or not is determined. The determination is carried out by determining whether the control section 10 accepted the operation signal indicating the completion of the maintenance/replacement which is generated by the key operation of an operator or not. When the maintenance/replacement operation is completed, the process moves to step S105, and when the maintenance/replacement is not completed, the process of step S104 is repeated.

When it is determined that the maintenance/replacement operation is completed, the malfunction detection function is turned ON in step S105.

In step S106, whether malfunction is detected by the malfunction detection sensors S1 to Sn or not is determined. When malfunction is detected, the process moves to step S108, and when malfunction is not detected, the process moves to step S107.

In step S107, the maintenance/replacement mode is finished and the operation mode is switched to the image forming mode automatically.

In step S108, whether the detected malfunction is related to a related part of the item selected in step S101 or not is determined. When the malfunction is related to the related part, the process moves to step S109, and when the malfunction is not related to the related part, the process moves to step S107.

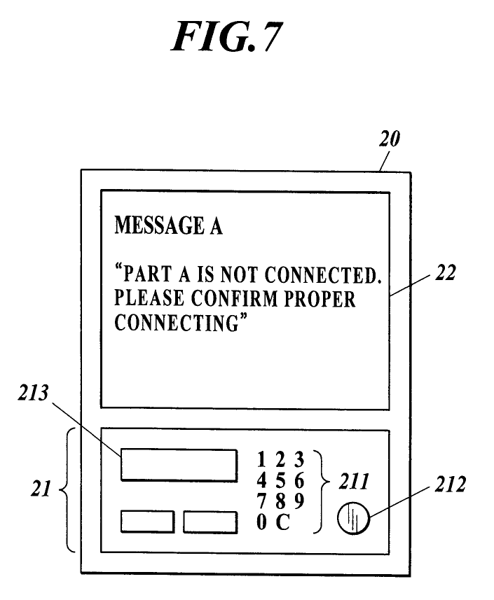

In step S109, a warning message according to the detected malfunction is displayed in the display section 22. For example, when it is detected that the part A is not connected, a message (for example, “Part A is not connected. Please confirm proper connecting.”) indicating that the part A is not connected is displayed in the display section 22 as shown in FIG. 7. When the warning message is displayed in the display section 22, the process moves to step S103 and the maintenance/replacement operation will be carried out again.

When the operation mode is switched to the image forming mode, whether malfunction is detected by the malfunction detection sensors S1 to Sn or not is determined in step S110. When malfunction is detected, the process moves to step S112, and when malfunction is not detected, the process moves to step S111.

In step S111, the image forming apparatus 100 will be in a standby state.

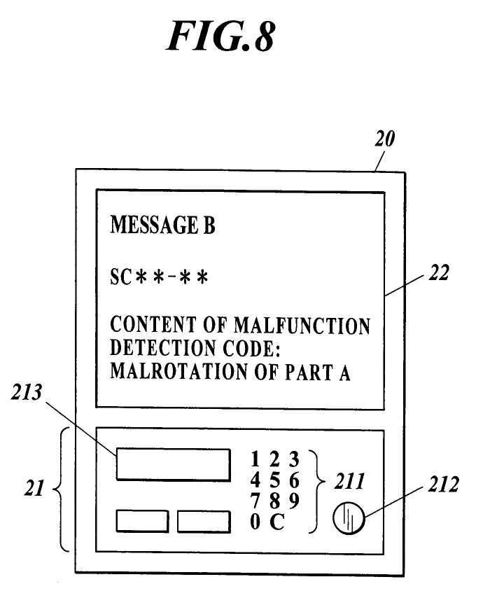

In step S112, a warning message (serviceman call) according to the detected malfunction is displayed in the display section 22. For example, when malrotation of part A is detected, a message (for example, “SC**-** content of malfunction detection code: malrotation of part A”) indicating the malrotation of part A is displayed in the display section 22 as shown in FIG. 8. Here, a serviceman call means displaying of an indication that there is a need to call a serviceman in the display section 22 at the same time as displaying the warning message in the display section 22.

In step S113, the image forming apparatus 100 will be in a stop state. Thereafter, the maintenance/replacement operation by a serviceman is to be carried out.

In such way, in the first embodiment, the malfunction detection function is turned OFF during the maintenance/replacement operation and the malfunction detection function is turned ON after the maintenance/replacement operation is completed to detect malfunction. Therefore, malfunction will not be detected during the maintenance/replacement operation, and downtime of the apparatus can be reduced. Further, the message to be displayed in the display section 22 is changed according to whether the operation mode at the time when malfunction is detected by the malfunction detection sensors S1 to Sn is the image forming mode or the maintenance/replacement mode. Therefore, a serviceman does not have to be called needlessly, and downtime of the apparatus can be reduced.

### Second Embodiment

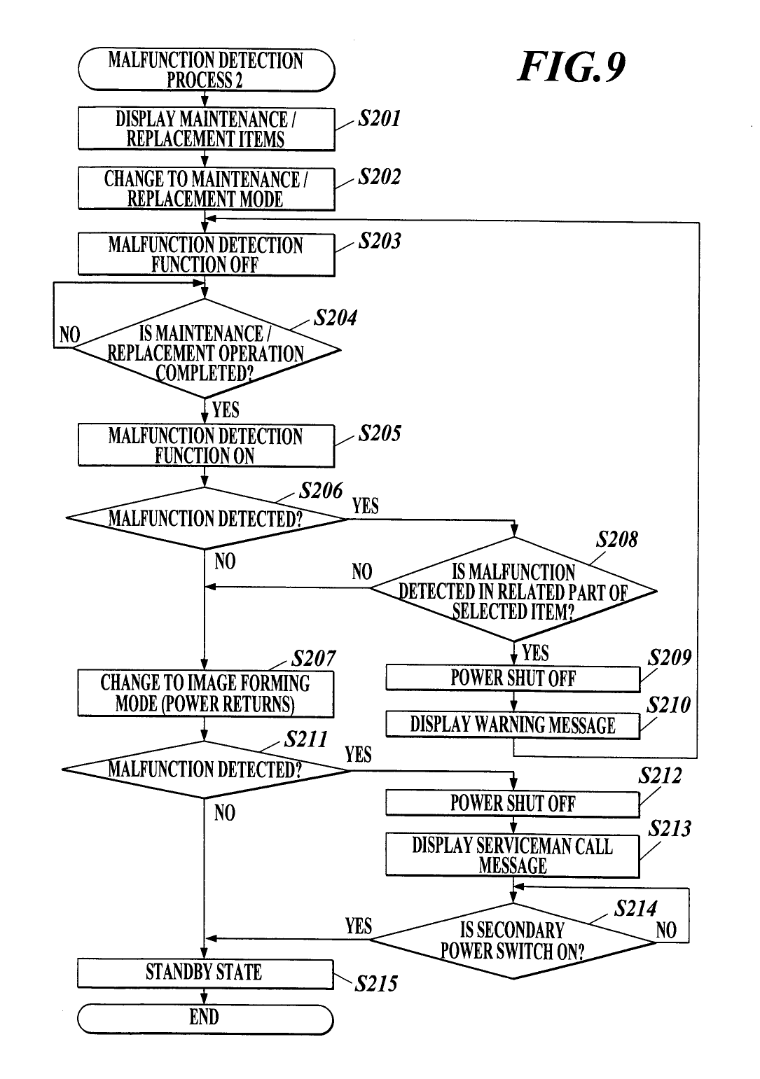

FIG. 9 is a flowchart showing an example (malfunction detection process 2) of the malfunction detection process which is carried out in the image forming apparatus 100 according to the embodiment.

When it is selected to carry out the maintenance/replacement by an operator, items which are targeted for the maintenance/replacement are displayed in step S201 as shown in FIG. 9. When the items which are targeted for maintenance/replacement is displayed, an item to which the maintenance/replacement is to be carried out is selected among the displayed items.

When the item to which the maintenance/replacement is to be carried out is selected, the operation mode is switched to the maintenance/replacement mode in step S202.

When the mode is switched to the maintenance/replacement mode, the function of the malfunction detection sensors S1 to Sn to detect malfunction (malfunction detection function) is turned OFF in step S203.

In step S204, whether the maintenance/replacement operation is completed or not is determined. When the maintenance/replacement operation is completed, the process moves to step S205, and when the maintenance/replacement operation is not completed, the process of step S204 is repeated.

When it is determined that the maintenance/replacement operation is completed, the malfunction detection function is turned ON in step S205.

In step S206, whether malfunction is detected by the malfunction detection sensors S1 to Sn or not is determined. When malfunction is detected, the process moves to step S208, and when malfunction is not detected, the process moves to step S207.

In step S207, the maintenance/replacement mode is finished and the operation mode is switched to the image forming mode automatically. Here, when the process reached step S207 via step S209, power is made to recover from the shut off state.

In step S208, whether the detected malfunction is related to a related part of the item selected in step S201 or not is determined. When the malfunction is related to the related part, the process moves to step S209, and when the malfunction is not related to the related part, the process moves to step S207.

In step S209, power supply to the related part in which malfunction is detected in step S208 is shut off.

In step S210, a warning message according to the detected malfunction is displayed in the display section 22. When the warning message is displayed in the display section 22, the process moves to step S203 and the maintenance/replacement operation is to be carried out again.

When the operation mode is switched to the image forming mode, whether malfunction is detected by the malfunction detection sensors S1 to Sn or not is determined in step S211. When malfunction is detected, the process moves to step S212, and when malfunction is not detected, the process moves to step S215.

In step S212, power supply to the related part in which malfunction is detected in step S211 will be shut off.

In step S213, a warning message (serviceman call) according to the detected malfunction is displayed in the display section 22.

In step S214, whether the secondary power switch is tuned ON or not is determined. When the secondary power switch is turned ON, the process moves to step S215, and when the secondary power is not turned ON, the process of step S214 is repeated.

In step S215, the image forming apparatus 100 will be in a standby state.

In such way, differently from the first embodiment, in the second embodiment, input and output of power supply to the selected unit which is targeted for maintenance/replacement is shut off when malfunction is detected by the malfunction detection sensors S1 to Sn, the power shut off is recovered only when the secondary power switch of the apparatus is turned ON when the timing of the malfunction detection is in the image forming mode and the power shut off is recovered when malfunction is not detected after input of maintenance/replacement is accepted when the timing of the malfunction detection is in the maintenance/replacement mode. Therefore, the maintenance/replacement by an operator can be carried out more safely.

In such way, target to which the maintenance/replacement can be carried out can be extended.

### Third Embodiment

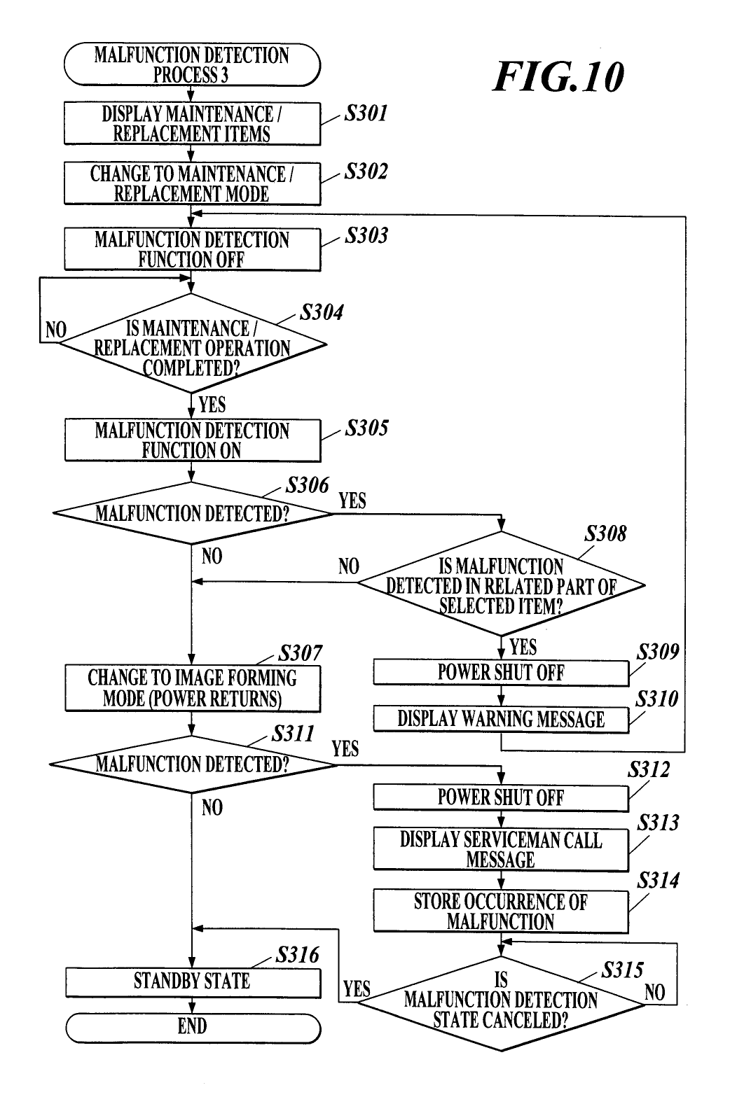

FIG. 10 is a flowchart showing an example (malfunction detection process 3) of the malfunction detection process which is carried out in the image forming apparatus 100 according to the embodiment.

When it is selected to carry out the maintenance/replacement by an operator, items which are targeted for maintenance/replacement are displayed in step S301 as shown in FIG. 10. When the items targeted for maintenance/replacement are displayed, an item to which the maintenance/replacement is to be carried out is selected among the displayed items.

When an item to which the maintenance/replacement is to be carried out is selected, the operation mode is switched to the maintenance/replacement mode in step S302.

When the operation mode is switched to the maintenance/replacement mode, the function of the malfunction detection sensors S1 to Sn to detect malfunction (malfunction detection function) is turned OFF in step S303.

In step S304, whether the maintenance/replacement operation is completed or not is determined. When the maintenance/replacement operation is completed, the process moves to step S305, and when the maintenance/replacement operation is not completed, the process of step S304 is repeated.

When it is determined that the maintenance/replacement operation is completed, the malfunction detection function is turned ON in step S305.

In step S306, whether malfunction is detected by the malfunction detection sensors S1 to Sn or not is determined. When malfunction is detected, the process moves to step S308, and when malfunction is not detected, the process moves to step S307.

In step S307, the maintenance/replacement mode is finished and the operation mode is switched to the image forming mode automatically. Here, when the process reaches step S307 via step S309, shut off state of power will be recovered.

In step S308, whether the detected malfunction is related to the related part of the item selected in step S301 or not is determined. When the malfunction is related to the related part, the process moves to step S309, and when the malfunction is not related to the related part, the process moves to step S307.

In step S309, power supply to the related part in which malfunction is detected in step S308 is shut off.

In step S310, a warning message according to the detected malfunction is displayed in the display section 22. When the warning message is displayed in the display section 22, the process moves to step S303 and the maintenance/replacement operation will be carried out again.

When the operation mode is switched to the image forming mode, whether malfunction is detected by the malfunction detection sensors S1 to Sn or not is determined in step S311. When malfunction is detected, the process moves to step S312, and when malfunction is not detected, the process moves to step S316.

In step S312, power supply to the related part in which malfunction is detected in step S311 is shut off. Further, the detected state of malfunction is stored in the main body memory 11.

In step S313, a warning message (serviceman call) according to the detected malfunction is displayed in the display section 22.

In step S314, occurrence record of malfunction is stored in the main body memory 11.

In step S315, whether the detected state of malfunction is canceled by a serviceman or not is determined. Here, canceling of the detected state of malfunction is carried out by a specific mode which can only be accessed by a serviceman. When the detected state of malfunction is canceled, the process moves to step S316, and when the detected state of malfunction is not canceled, the process of step S315 is repeated.

In step S316, the image forming apparatus 100 will be in a standby state.

In such way, in the third embodiment, the detected state of malfunction which is stored in the main body memory 11 can be canceled only by the operation mode which can only be accessed by a serviceman when malfunction is detected in the image forming mode and the detected state of malfunction is not allowed to be stored in the main body memory 11 when malfunction is detected in the maintenance/replacement mode. In such way, a serviceman can be called surely when maintenance/replacement which should be carried out by a serviceman is needed such as in a case where a breakdown of a part that is difficult for an operator to carryout its maintenance/replacement occurred.

Thereby, safer maintenance/replacement operation can be carried out.

Detail description is given based on the embodiments of the present invention as described above. However, the present invention is not limited to the above embodiments, and can be modified within the scope of the invention.

For example, in the above embodiments, the serviceman call which urges to call a serviceman is displayed in the display section 22 when the operation mode at the time when malfunction is detected is the image forming mode and the indication (warning message) for urging a user to carry out the maintenance/replacement operation is displayed in the display section 22 and not the serviceman call when the operation mode at the time when malfunction is detected is the maintenance/replacement mode. However, there may be a case where a message similar to the warning message which is displayed when malfunction is detected in the maintenance/replacement mode is displayed when malfunction is detected in the image forming mode. For example, in a case such as when malfunction in which the front cover is kept open is detected, there is no need to call a serviceman and there is no need to display the serviceman call. That is, a control which is different from a regular maintenance/replacement can be carried out by changing the control of the image forming apparatus 100 according to the type of malfunction detected by the malfunction detection sensors S1 to Sn.

Moreover, in the above embodiments, the occurrence record of malfunction is stored in the main body memory 11. However, the occurrence record of malfunction can be also displayed in the display section 22. Here, the occurrence record of malfunction can be stored so as to be discriminated by the operation modes at the time when the malfunction is detected and can be displayed in the display section 22. Therefore, for example, only the occurrence record of malfunction in the image forming mode can also be displayed.

According to a first aspect of the preferred embodiments of the present invention, there is provided an image forming apparatus comprising a unit in which a replaceable part is loaded, an image forming section to form an image on a recording medium by an operation of the unit, a malfunction detection section to detect a malfunction of the unit or the part and a control section to carry out a control of the image forming apparatus, and when an operation mode to executed an image forming by the image forming section is an image forming mode and when the operation mode which allows a maintenance/replacement of the unit is a maintenance/replacement mode, the control section changes a control of the image forming apparatus according to whether the operation mode when the malfunction was detected by the malfunction detection section is the image forming mode or the maintenance/replacement mode.

Preferably, the control section changes the control of the image forming apparatus according to a type of the malfunction which is detected by the malfunction detection section.

Preferably, the image forming apparatus further comprises a display section, and the control section changes a message to be displayed in the display section according to whether the operation mode when the malfunction was detected by the malfunction detection section is the image forming mode or the maintenance/replacement mode.

Preferably, the control section makes the display section display a serviceman call to urge a calling of a serviceman when the operation mode when the malfunction was detected is the image forming mode, and the control section makes the display section display an indication to urge a user to carry out the maintenance/replacement operation and not the serviceman call when the operation mode when the malfunction was detected is the maintenance/replacement mode.

Preferably, the image forming apparatus further comprises an operation section to accept a selection input of an item which is to be targeted for the maintenance/replacement, and the control section switched the operation mode to the maintenance/replacement mode from the image forming mode when the selection input of the item by the operation section is accepted.

Preferably, the image forming apparatus further comprises an operation section to accept an input of a maintenance/replacement completion, and the control section switches the operation mode to the image forming mode from the maintenance/replacement mode when the input of the maintenance/replacement completion by the operation section is accepted.

Preferably, the image forming apparatus further comprises a power control section to control an input and output of a power supply to the unit, and the control section shuts off the input and output of the power supply to the unit by the power control section when the malfunction is detected by the malfunction detection section, the control section makes a shut off state be recovered only when a secondary power switch of the image forming apparatus is turned on in a case where a timing when the malfunction was detected is in the image forming mode and the control section makes the shut off state be recovered when the malfunction is not detected after an input of a maintenance/replacement completion is accepted in a case where the timing when the malfunction was detected is in the maintenance/replacement mode.

Preferably, the image forming apparatus further comprises a storage section to store a detected state of the malfunction which is detected by the malfunction detection section, and the control section allows the detected state of the malfunction stored in the storage section be canceled only by an operation mode which is only allowed to be accessed by a serviceman when the malfunction is detected in the image forming mode and the control section does not allow storing of the detected state of the malfunction by the storage section when the malfunction is detected in the maintenance/replacement mode.

Preferably, the image forming apparatus further comprises a storage section to store an occurrence record of the malfunction which is detected by the malfunction detection section, and the control section allows the occurrence record of the malfunction be stored in the storage section so as to discriminate between each of the operation modes when the malfunction was detected and the control section allows the occurrence record of the malfunction which is stored in the storage section be displayed in the display section.

In the image forming apparatus, the target to which the maintenance/replacement operation can be carried out can be extended, and also, the downtime associated with the maintenance/replacement operation can be reduced.

The present U.S. patent application claims the priority of Japanese Patent Application No. 2008-319266 filed on Dec. 16, 2008 according to the Paris Convention, and the above Japanese Patent Applications are the basis for correcting mistranslation of the present U.S. patent application.

What is claimed is:

1. An image forming apparatus, comprising:
a unit in which a replaceable part is loaded;
an image forming section to form an image on a recording medium by an operation of the unit;
a malfunction detection section to detect a malfunction of the unit or the part; and
a control section to carry out a control of the image forming apparatus, wherein
when an operation mode to executed an image forming by the image forming section is an image forming mode and when an operation mode which allows a maintenance/replacement of the unit is a maintenance/replacement mode, the control section changes a control of the image forming apparatus according to whether the operation mode when the malfunction was detected by the malfunction detection section is the image forming mode or the maintenance/replacement mode.

2. The image forming apparatus of claim 1, wherein the control section changes the control of the image forming apparatus according to a type of the malfunction which is detected by the malfunction detection section.

3. The image forming apparatus of claim 1, further comprising a display section, wherein
the control section changes a message to be displayed in the display section according to whether the operation mode when the malfunction was detected by the malfunction detection section is the image forming mode or the maintenance/replacement mode.

4. The image forming apparatus of claim 3, wherein
the control section makes the display section display a serviceman call to urge a calling of a serviceman when the operation mode when the malfunction was detected is the image forming mode, and
the control section makes the display section display an indication to urge a user to carry out the maintenance/replacement operation and not the serviceman call when the operation mode when the malfunction was detected is the maintenance/replacement mode.

5. The image forming apparatus of claim 1, further comprising an operation section to accept a selection input of an item which is to be targeted for the maintenance/replacement, wherein
the control section switched the operation mode to the maintenance/replacement mode from the image forming mode when the selection input of the item by the operation section is accepted.

6. The image forming apparatus of claim 1, further comprising an operation section to accept an input of a maintenance/replacement completion, wherein
the control section switches the operation mode to the image forming mode from the maintenance/replacement mode when the input of the maintenance/replacement completion by the operation section is accepted.

7. The image forming apparatus of claim 1, further comprising a power control section to control an input and output of a power supply to the unit, wherein
the control section shuts off the input and output of the power supply to the unit by the power control section when the malfunction is detected by the malfunction detection section,
the control section makes a shut off state be recovered only when a secondary power switch of the image forming apparatus is turned on in a case where a timing when the malfunction was detected is in the image forming mode, and
the control section makes the shut off state be recovered when the malfunction is not detected after an input of a maintenance/replacement completion is accepted in a case where the timing when the malfunction was detected is in the maintenance/replacement mode.

8. The image forming apparatus of claim 7, further comprising a storage section to store a detected state of the malfunction which is detected by the malfunction detection section, wherein
the control section allows the detected state of the malfunction stored in the storage section be canceled only by an operation mode which is only allowed to be accessed by a serviceman when the malfunction is detected in the image forming mode, and
the control section does not allow storing of the detected state of the malfunction by the storage section when the malfunction is detected in the maintenance/replacement mode.

9. The image forming apparatus of claim 1, further comprising a storage section to store an occurrence record of the malfunction which is detected by the malfunction detection section, wherein
the control section allows the occurrence record of the malfunction be stored in the storage section so as to discriminate between each of the operation modes when the malfunction was detected, and
the control section allows the occurrence record of the malfunction which is stored in the storage section be displayed in the display section.
